(19) United States
(12) Patent Application Publication
(10) Pub. No.: US 2026/0147139 A1
(43) Pub. Date: May 28, 2026

(54) OPTICAL LENS

(71) Applicant: AAC OPTICS (CHANGZHOU) CO., LTD., Changzhou (CN)

(72) Inventors: Huaiyu Chen, Changzhou (CN); Jia Wang, Changzhou (CN)

(21) Appl. No.: 19/073,045

(22) Filed: Mar. 7, 2025

Related U.S. Application Data
(63) Continuation of application No. PCT/CN2024/133858, filed on Nov. 22, 2024.

(51) Int. Cl. G02B 1/11

(52) U.S. Cl. CPC G02B 1/11

(57) ABSTRACT

An optical lens includes a lens body, a first intermediate layer, a second intermediate layer, a first antireflection film layer and a second antireflection film layer. The second intermediate layer has a smaller refractive index than the first intermediate layer. The second antireflection film layer has a smaller equivalent refractive index than the first antireflection film layer. A material of the first intermediate layer includes aluminum oxide, and/or a material of the second intermediate layer includes silicon-aluminum mixture or silicon dioxide. The first antireflection film layer and the second antireflection film layer include silica spherical particles, and a diameter of silica spherical particles in the first antireflection film layer is greater than a diameter of silica spherical particles in the second antireflection film layer. The present disclosure can improve the real-shot fogging and surface shape changes under high temperature and high humidity conditions, while maintaining ultra-low reflectivity.

### TECHNICAL FIELD

The present disclosure relate to the field of optical lenses, and in particular to an optical lens.

### BACKGROUND

With the development of terminal technology, a shooting function has become an important feature of smart terminals and a key indicator for evaluating performance of the terminals.

In order to improve the image quality captured by the camera, optical lenses are typically formed on the surface of the lens. However, due to high reflectivity of optical lenses, the improvement in image quality has not met expectations. Currently, the hydrolysis process of aluminum oxide is commonly used to obtain cameras with low reflectivity. However, this process can lead to fogging issues in real-shot. Meanwhile, for lenses made of hygroscopic material such as EP, OKP, SP, PMMA, physical vapor deposition (PVD coating) of optical films are usually performed followed by environmental test under high temperature and high humidity. The surface shape of the lens changes greatly, which affects the lens reliability and the MTF (modulation transfer function) performance.

Therefore, it is necessary to provide an optical lens, which can improve the real-shot fogging and surface shape changes under high temperature and high humidity conditions, while maintaining ultra-low reflectivity.

### SUMMARY

The present disclosure provides an optical lens, which can improve the real-shot fogging and surface shape changes under high temperature and high humidity conditions, while maintaining ultra-low reflectivity.

An aspect of an embodiment of the present disclosure provides an optical lens. An optical lens includes: a lens body; and a composite film layer covering on the lens body. The composite film layer includes a first intermediate layer, a second intermediate layer, a first antireflection film layer and a second antireflection film layer. The first intermediate layer covers on a surface of the lens body, the second intermediate layer covers on a surface of the first intermediate layer facing away from the lens body, the first antireflection film layer covers on a surface of the second intermediate layer facing away from the first intermediate layer, and the second antireflection film layer covers on a surface of the first antireflection film layer facing away from the second intermediate layer. The second intermediate layer has a smaller refractive index than the first intermediate layer, and the second antireflection film layer has a smaller equivalent refractive index than the first antireflection film layer. A material of the first intermediate layer includes aluminum oxide, and/or a material of the second intermediate layer includes silicon-aluminum mixture or silicon dioxide. The first antireflection film layer and the second antireflection film layer include silica spherical particles. A diameter of silica spherical particles in the first antireflection film layer is greater than a diameter of silica spherical particles in the second antireflection film layer.

As an improvement, an equivalent refractive index of the first antireflection film layer is smaller than a refractive index of the second intermediate layer.

As an improvement, an equivalent refractive index of the first antireflection film layer ranges from 1.2 to 1.35, and/or a refractive index of the second intermediate layer ranges from 1.38 to 1.55.

As an improvement, a refractive index of the first intermediate layer ranges from 1.55 to 1.73, and/or an equivalent refractive index of the second antireflection film layer ranges from 1.06 to 1.16.

As an improvement, a thickness of the first intermediate layer is smaller than a thickness of the second intermediate layer, and/or an equivalent thickness of the first antireflection film layer is smaller than an equivalent thickness of the second antireflection film layer.

As an improvement, a thickness of the second intermediate layer is smaller than an equivalent thickness of the first antireflection film layer.

As an improvement, a thickness of the first intermediate layer ranges from 70 nm to 76 nm, and/or a thickness of the second intermediate layer ranges from 75 nm to 80 nm, and/or an equivalent thickness of the first antireflection film layer ranges from 83 nm to 95 nm, and/or an equivalent thickness of the second antireflection film layer ranges from 100 nm to 115 nm.

As an improvement, a material of the lens body includes EP material, OKP material, SP material or PMMA material.

The technical solutions provided by the embodiments of the present disclosure have at least the following advantages. Firstly, the first intermediate layer and the second intermediate layer are sequentially arranged on the composite film layer on the lens body, so that reliability of the optical lens is improved, thereby avoiding abnormalities caused by temperature and humidity. Moreover, by arranging the first intermediate layer, the equivalent refractive indexes of the second intermediate layer, the first antireflection film layer and the second antireflection film layer can be adjusted, thereby reducing the reflectivity of the optical lens. Secondly, the second intermediate layer has a smaller refractive index than the first intermediate layer, and the second antireflection film layer has a smaller equivalent refractive index than the first antireflection film layer, so that the reflection of light entering the first antireflection film layer from the second antireflection film layer is reduced, and the reflection of light entering the first intermediate layer from the second intermediate layer is reduced, thereby improving the clarity of an image on the optical lens. Finally, controlling the materials of the first intermediate layer and the second intermediate layer can facilitate the control of the performance of the first intermediate layer and the second intermediate layer. Controlling the sizes of silicon dioxide spherical particles of the first antireflection layer and the second antireflection layer can control pores of the first antireflection layer and the second antireflection layer, thereby adjusting the equivalent refractive indexes of the first antireflection layer and the second antireflection layer.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a partial structural schematic diagram of an optical lens according to some embodiments of the present disclosure;

FIG. 2 is a curve of reflectivity of an optical lens according to some embodiments of the present disclosure when light with different incident angles and different wavelengths enters the optical lens; and

FIG. 3 is a curve of reflectivity of an optical lens before and after testing according to some embodiments of the present disclosure.

### DESCRIPTION OF EMBODIMENTS

At present, in order to improve the quality of the image shot by the camera, a composite film is usually formed on the surface of the lens. In the related art, some portable electronic devices have adopted a new coating technology—aluminum oxide hydrolysis process, which can achieve ultra-low reflectivity (visible light band, reflectivity reaches 0.1%), significantly improving camera ghosting and overall image quality. However, the process has the problem of real-shot fogging due to scattering characteristics, and especially when this process is applied to multiple lenses in a single camera, which makes it easier to highlight the problem.

Embodiments of the present disclosure provide an optical lens. Firstly, the first intermediate layer and the second intermediate layer are sequentially arranged on the composite film layer on the lens body, thereby improving the reliability of the optical lens, and thus avoiding abnormalities caused by temperature and humidity. Moreover, by arranging the first intermediate layer, the equivalent refractive indexes of the second intermediate layer, the first antireflection film layer and the second antireflection film layer can be adjusted, thereby reducing the reflectivity of the optical lens. Secondly, the second intermediate layer has a smaller refractive index than the first intermediate layer, and the second antireflection film layer has a smaller equivalent refractive index than the first antireflection film layer, thereby reducing the reflection of light entering the first antireflection film layer from the second antireflection film layer, and reducing the reflection of light entering the first intermediate layer from the second intermediate layer, and thus improving the clarity of an image on the optical lens. Moreover, setting the equivalent refractive index of the second antireflection film layer to be low can also improve the problem of real-shot fogging. Finally, controlling the material of the first intermediate layer and the second intermediate layer can facilitate the control of the performance of the first intermediate layer and the second intermediate layer. Controlling the sizes of silicon dioxide spherical particles of the first antireflection layer and the second antireflection layer can control pores of the first antireflection layer and the second antireflection layer, thereby adjusting the equivalent refractive indexes of the first antireflection layer and the second antireflection layer.

In the description of embodiments of the present disclosure, technical terms “first”, “second” and the like are only intended to distinguish different objects, which shall not be construed as indicating or implying a relative importance, or implicitly specifying the number, a particular order or primary and secondary relations of the indicated technical features. In the description of the embodiments of the present disclosure, “a plurality of” means two or more, unless specifically limited otherwise.

The “embodiments” mentioned herein means that particular features, structures or characteristics described with reference to the embodiments can be included in one or more embodiments of the present disclosure. The appearances of such phrase in various places in the specification may not be necessarily all referring to a same embodiment, nor an independent or alternative embodiment that are mutually exclusive with other embodiments. The embodiments described herein may be combined with other embodiments.

It should be understood that the term “and/or” used in the present disclosure represents an association relationship to describe associated objects, and can indicate three relationships, for example, A and/or B can indicate A alone, A and B, and B alone. In addition, the character “/” herein generally means an “or” relationship between the preceding and subsequent associated objects.

In the description of the embodiments of the present disclosure, the term “multiple” in means more than two (including two), similarly, “multiple groups” means more than two groups (including two groups), and “multiple pieces” means more than two (including two pieces).

In the description of embodiments of the present disclosure, the orientation or position relationship indicated by the technical terms such as “central”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumferential” are based on the orientation or position relationship shown in the accompanying drawings and are only intended to facilitate the description of embodiments of the present disclosure and simplify the description, rather than indicating or implying that the device or element referred to must have a particular orientation or be constructed and operated in a particular orientation, and therefore are not to be interpreted as limitations on the embodiments of the present disclosure.

In the description of embodiments of the present disclosure, unless specifically stated and limited, the technical terms “mounting”, “coupling”, “connecting” and “fixing” should be understood in a broad sense, such as, a fixed connection, a detachable connection, or an integral connection; a mechanical connection or an electrical connection; a direct connection, an indirect connection through an intermediate medium, an internal connection of two elements, or an interaction of two elements. For those of ordinary skill in the art, the specific meanings of the above terms in embodiments of the present disclosure can be understood on case-by-case.

In the accompanying drawings corresponding to the embodiments of the present disclosure thickness and area of layers are enlarged for better understanding and ease of description. When describing a component, such as a layer, film, region or lens body, on another component or on a surface of another component, the component may be “directly” on the surface of another component, or there may be a third component between the two components. Conversely, when a component is on a surface of another component or another component is formed on a surface of a component, or another component is provided on a surface of a component, it means that there is no third component between the two components. Furthermore, when a component is “substantially” formed on another component, it means that the component is not formed on the entire surface (or front surface) of the other component, nor on a partial edge of the entire surface.

In the description of the embodiments of the present disclosure, when a component “includes” another component, other components are not excluded unless otherwise specified, and other components may be further included. Further, when a component such as a layer, a film, a region, or a plate is referred to as being “on/at” another component, it may be “directly on” the other component (there is no other component between the surfaces of the other component), or there may be another component there between. Further, when a component such as a layer, a film, a region, or a plate is “directly on” another component, or when a component such as a layer, a film, a region, or a plate is on a surface of another component, it indicates that no other component is located there between.

Terms used in the description of the various embodiments described herein are only intended to describe specific embodiments and are not intended to be limited. As used in the description of the various embodiments described herein and the appended claims, “the component” is also intended to include plural forms unless the context clearly indicates otherwise. The components include layers, films, regions or plates.

The embodiments of the present disclosure will be described in detail below with reference to the drawings. However, those skilled in the art will appreciate that in various embodiments of the present disclosure, numerous technical details are set forth for the reader to better understand the present disclosure. However, even without these technical details and various variations and modifications based on the following embodiments, the technical solutions claimed in the present disclosure can still be implemented.

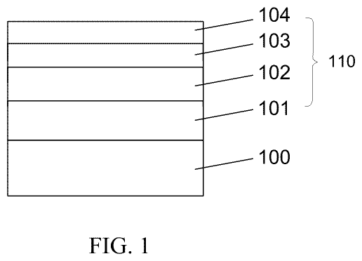

Referring to FIG. 1, which is a schematic structural diagram of an optical lens according to the present disclosure.

In some embodiments, the optical lens may include a lens body 100 and a composite film layer 110 covering on the lens body 100.

The composite film layer 110 includes a first intermediate layer 101 covering on a surface of the lens body 100.

The composite film layer 110 further includes a second intermediate layer 102 covering on a surface of the first intermediate layer 101 facing away from the lens body 100.

The composite film layer 110 further includes a first antireflection film layer 103 covering on a surface 101 of the second intermediate layer 102 facing away from the first intermediate layer.

The composite film layer 110 further includes a second antireflection film layer 104 covering on a surface of the first antireflection film layer 103 facing away from the second intermediate layer 102. A refractive index of the second intermediate layer 102 is smaller than a refractive index of the first intermediate layer 101. An equivalent refractive index of the second antireflection film layer 104 is smaller than an equivalent refractive index of the first antireflection film layer 103. The material of the first intermediate layer 101 includes aluminum oxide. The material of the second intermediate layer 102 includes silicon-aluminum mixture or silicon dioxide. The first antireflection film layer 103 and the second antireflection film layer 104 include spherical silica particles. A diameter of the silica spherical particles in the first antireflection film layer 103 is greater than a diameter of the silica spherical particles in the second antireflection film layer 104. A diameter of the silica spherical particles of the first antireflection film layer 103 ranges from 100 nm to 300 nm, and a diameter of the silica spherical particles of the second antireflection film layer 104 ranges from 50 nm to 200 nm.

Embodiments of the present disclosure provide an optical lens. Firstly, the first intermediate layer 101 and the second intermediate layer 102 are sequentially arranged on the composite film layer 110 on the lens body 110, thereby improving the reliability of the optical lens, and thus avoiding abnormalities caused by temperature and humidity. Moreover, by arranging the first intermediate layer 101, the equivalent refractive indexes of the second intermediate layer 102, the first antireflection film layer 103 and the second antireflection film layer 104 can be adjusted, thereby reducing the reflectivity of the optical lens. Secondly, the refractive index of the second intermediate layer 102 is smaller than the refractive index of the first intermediate layer 101, and the equivalent refractive index of the second antireflection film layer 104 is smaller than the equivalent refractive index of the first antireflection film layer 103, so that the reflection of light entering the first antireflection film layer 103 from the second antireflection film layer 104 is reduced, and the reflection of light entering the first intermediate layer 101 from the second intermediate layer 102 is reduced, and thereby improving the clarity of an image on the optical lens. Moreover, setting the equivalent refractive index of the second antireflection film layer 104 to be low can also improve the problem of real-shot fogging. Finally, controlling the material of the first intermediate layer 101 and the second intermediate layer 102 can facilitate the control of the performance of the first intermediate layer and the second intermediate layer. Controlling the sizes of silicon dioxide spherical particles of the first antireflection layer 101 and the second antireflection layer 102 can control pores of the first antireflection layer 103 and the second antireflection layer 104, thereby adjusting the equivalent refractive indexes of the first antireflection layer 103 and the second antireflection layer 104.

In some embodiments, the material of the lens body 100 includes hygroscopic material such as EP (EP Polymer Ethylene-Propylene Copolymer) material, OKP (Petrochemical Derivative Plastic) material, SP (Spandex, also known as Elastane) material, or PMMA (Polymethyl Methacrylate) material. For these materials, they are prone to adsorbing water vapor from the air, resulting in significant changes in the surface shape of the lens body 100, which can affect the overall reliability. Therefore, by sequentially arranging the first intermediate layer 101, the second intermediate layer 102, the first antireflection film layer 103 and the second antireflection film layer 104 on the surface of the lens body 100, the overall high-temperature and high-humidity resistance performance of the optical lens can be improved, thereby avoiding failure of optical lens.

For the first intermediate layer 101, the refractive index of the first intermediate layer 101 may be 1.55 to 1.73, for example, 1.57, 1.6, 1.63, 1.67, 1.7, or 1.72. For the first intermediate layer 101, setting the refractive index of the first intermediate layer 101 higher may affect the dispersion coefficient of the final imaging pattern. The smaller the refractive index of the first intermediate layer 101, the more likely it is to cause reflection of light on a surface of the first intermediate layer 101. Therefore, setting the refractive index of the first intermediate layer 101 to be 1.55 to 1.73 can reduce the reflection of light on the surface of the first intermediate layer 101 while compromising the dispersion coefficient of the imaging pattern, thereby improving the performance of the optical lens.

The thickness of the first intermediate layer 101 may range from 70 nm to 76 nm, for example, 71 nm, 72 nm, 73 nm, 74 nm or 75 nm. For the first intermediate layer 101, setting the thickness of the first intermediate layer 101 to be 70 nm to 76 nm can reduce the reflectivity of the optical lens as much as possible while ensuring the reliability of the optical lens.

In some embodiments, the material of the first intermediate layer 101 may include aluminum oxide.

For the second intermediate layer 102, the refractive index of the second intermediate layer 102 may range from 1.38 to 1.55, for example, 1.39, 1.43, 1.46, 1.5, or 1.53. For the second intermediate layer 102, setting the refractive index of the second intermediate layer 102 higher may affect the dispersion coefficient of the final imaging pattern. The smaller the refractive index of the second intermediate layer 102, the more likely it is to cause reflection of light on a surface of the second intermediate layer 102. Therefore, setting the refractive index of the second intermediate layer 102 to range from 1.55 to 1.73 can reduce the reflection of light on the surface of the second intermediate layer 102 while compromising the dispersion coefficient of the imaging pattern, thereby improving the performance of the optical lens.

For the second intermediate layer 102, the refractive index of the second intermediate layer 102 is calculated and optimized based on the first intermediate layer 101, so as to cooperate with the first intermediate layer 101 to reduce the overall reflectivity of the optical lens, thereby forming an optical lens with an ultra-low reflectivity.

In some embodiments, the thickness of the first intermediate layer 101 is smaller than the thickness of the second intermediate layer 102. It can be understood that the first intermediate layer 101 is a film layer closest to the lens body 100. That is to say, the light will pass through the first intermediate layer 101 and irradiate the surface of the lens body 100. The thicker the first intermediate layer 101, the higher the probability of reflection and diffuse reflection. Therefore, in order to improve the imaging quality of the image on the lens body 100, the thickness of the first intermediate layer 101 is controlled to be smaller than that of the second intermediate layer 102, thereby avoiding excessive loss of light in the first intermediate layer 101 and further reducing the reflectivity of the optical lens. Moreover, due to the high refractive index of the first intermediate layer 101, even if the thickness of the first intermediate layer 101 is reduced, the optical effect can be ensured, thereby reducing costs while achieving the optical effect of the first intermediate layer 101.

In some embodiments, the thickness of the second intermediate layer 102 ranges from 75 nm to 80 nm. By setting the thickness of the second intermediate layer 102 to be 75 nm-80 nm, the optimal thickness of the second intermediate layer 102 is obtained based on the first intermediate layer 101. Within this thickness range, the overall reflectivity of the optical lens can be reduced as much as possible while achieving the reliability of the second intermediate layer 102.

In some embodiments, setting the material of the second intermediate layer 102 to be a silicon-aluminum mixture or silicon dioxide may facilitate controlling the refractive index of the second intermediate layer 102. Moreover, under the premise that the material of the first intermediate layer 101 is aluminum oxide, setting the material of the second intermediate layer 102 as a silicon aluminum mixture or silicon dioxide can reduce the lattice mismatch at the contact interface between the first intermediate layer 101 and the second intermediate layer 102, thereby improving the reliability of the connection between the first intermediate layer 101 and the second intermediate layer 102.

For the first antireflection film layer 103, the equivalent refractive index of the first antireflection film layer 103 may be smaller than the refractive index of the second intermediate layer 102. In this way, a structure in which the equivalent refractive indexes are sequentially reduced in a direction from the lens body 100 to the second antireflection film layer 104 is formed. In this way, during the process of light incidence, although the medium changes, the probability of light reflection in different media decreases, thereby reducing the reflectivity of optical lenses. Moreover, providing a structure where the equivalent refractive index decreases sequentially can avoid abnormity caused by sudden changes in refractive index.

In some embodiments, the equivalent refractive index of the first antireflection film layer 103 may range from 1.2 to 1.35, for example, 1.21, 1.25, 1.27, 1.3, 1.32 or 1.34. By controlling the equivalent refractive index of the first antireflection film layer 103 to range from 1.2 to 1.35, the overall reflectivity of the optical lens is reduced while improving the clarity of subsequent image.

It should be noted that, in the process of forming the first antireflection film layer 103, there may be cases in which refractive indexes at various positions are different. For example, it is necessary to form a first antireflection film layer 103 with a refractive index of 1.3. Ideally, the refractive index of the first antireflection film layer 103 at all positions should be 1.3. However, in practical situations, there may be some positions with a refractive index higher than 1.3 and some positions with a refractive index lower than 1.3. Therefore, the above refractive index is explained with the equivalent refractive index, which is actually the desired refractive index under ideal conditions. Moreover, the equivalent reflectivity of this heterogeneous layer can be obtained by simulating the equivalent refractive index of the film layer using MacLeod software.

In some embodiments, the equivalent thickness of the first antireflection film layer 103 can be controlled by controlling the porosity of the first antireflection film layer 103. The smaller the porosity of the first antireflection film layer 103, the greater the equivalent refractive index of the first antireflection film layer 103. The larger the porosity of the first antireflection film layer 103, the smaller the equivalent refractive index of the first antireflection film layer 103.

In some embodiments, the equivalent thickness of the first antireflection film layer 103 ranges from 83 nm to 95 nm, for example, 85 nm, 87 nm, 90 nm, 91 nm or 94 nm. By setting the equivalent thickness of the first antireflection film layer 103 to range from 83 nm to 95 nm, the reflectivity of the optical lens can be reduced while achieving the reliability of the first antireflection film layer 103, thereby reducing the interference of the external environment on the first antireflection film layer 103, and thus avoiding the failure of the first antireflection film layer 103.

It should be noted that during the process of forming the first antireflection film layer 103, there may be situations where some positions are thicker and some positions are thinner. For example, it is necessary to form a first antireflection film layer 103 with a thickness of 85 nm. Ideally, the thickness of each position of the first antireflection film layer 103 should be 85 nm. However, in practical situations, there may be some positions with a thickness of 87 nm or below 85 nm. Therefore, the above thickness is explained with the equivalent thickness, which is actually the desired thickness under ideal conditions. Moreover, the equivalent thickness of this heterogeneous layer can be obtained by simulating the equivalent thickness using MacLeod software.

In some embodiments, the thickness of the second intermediate layer 102 may be smaller than the equivalent thickness of the first antireflection film layer 103. By setting the thickness of the second intermediate layer 102 to be smaller than the equivalent thickness of the first antireflection film layer 103, the reflection or transmission of light in the second intermediate layer 102 and the first antireflection film layer 103 can be effectively controlled, so that the reflection of light between the second intermediate layer 102 and the first antireflection film layer 103 is reduced, and the transmission of light between the second intermediate layer 102 and the first antireflection film layer 103 is increased, thereby improving the performance of the optical lens.

The first antireflection film layer 103 may be a micro-nano film layer structure (LSC film), which further has properties of smooth structure and low scattering rate, thus solving the problem of real-shot fogging through the first antireflection film layer 103. Meanwhile, the looseness and low stress of the first antireflection film layer 103 can improve the high temperature and high humidity resistance of the optical lens.

For the second antireflection film layer 104, an equivalent refractive index of the second antireflection film layer 104 may be 1.06 to 1.16, for example, 1.1, 1.11, 1.12, 1.13, 1.14, or 1.16. By setting the equivalent refractive index of the second antireflection film layer 104 to range from 1.06 to 1.16, the difference in refractive index between the second antireflection film layer 104 and the air can be reduced, so that reflection and scattering of light between film layers when the light is incident on the second antireflection film layer 104 is reduced, thereby improving the clarity of the final image.

In some embodiments, providing an optical lens to include a first intermediate layer 101, a second intermediate layer 102, a first antireflection film layer 103, and a second antireflection film layer 104 can repeatedly reflect and refract along the path of light, a mutual interference effect is formed, thereby achieving the goal of reducing reflected light and increasing transmitted light.

In some embodiments, the equivalent thickness of the second antireflection film layer 104 can be controlled by controlling the porosity of the second antireflection film layer 104. The smaller the porosity of the second greater film layer 104, the greater the equivalent refractive index of the second greater film layer 104. The larger the porosity of the second greater film layer 104, the smaller the equivalent refractive index of the second greater film layer 104.

In some embodiments, an equivalent thickness of the second antireflection film layer 104 ranges from 100 nm to 115 nm, for example, 105 nm, 107 nm, 109 nm, 110 nm, 112 nm, or 114 nm. The thicker the second antireflection film layer 104, the higher the reflectivity of the second antireflection film layer 104. Meanwhile, the thicker the second antireflection film layer 104, the stronger the ability to improve the high temperature and high humidity resistance of the optical lens. Therefore, the equivalent thickness of the second antireflection film layer 104 is set to be 100 nm-115 nm. While considering the reliability of the optical lens, the reflectivity of the second antireflection film layer 104 is controlled.

In some embodiments, an equivalent thickness of the first antireflection film layer 103 is smaller than an equivalent thickness of the second antireflection film layer 104. By setting the equivalent thickness of the first antireflection film layer 103 to be smaller than the equivalent thickness of the second antireflection film layer 104, the reflection or transmission of light on the first antireflection film layer 103 and the second antireflection film layer 104 can be effectively controlled, so that the reflection of light between the first antireflection film layer 103 and the second antireflection film layer 104 is reduced, and the transmission of light between the first antireflection film layer 103 and the second antireflection film layer 104 is increased, thereby improving the performance of the optical lens.

In some embodiments, in a direction from the lens body 100 to the second antireflection film layer 104, equivalent thickness of the first intermediate layer 101, the second intermediate layer 102, the first antireflection film layer 103, and the second antireflection film layer 104 are sequentially increased. The reduction of the thickness of the film layer may result in a decrease of the optical path difference, which can improve the accuracy of forming a pattern on the surface of the lens body 100.

The diameter of the spherical particles in the first antireflection film layer 103 is large, resulting in small pores in the first antireflection film layer 103 and a high equivalent refractive index of the first antireflection film layer 103. The diameter of the spherical particles in the second antireflection film layer 104 is small, resulting in large pores in the second antireflection film layer 104 and a low equivalent refractive index, thereby reducing the reflection of light entering the first antireflection film layer 103 from the second antireflection film layer.

The second antireflection film layer 104 may be a micro-nano film layer structure (LSC film), which further has properties of smooth structure and low scattering rate, thus solving the problem of real-shot fogging through the second antireflection film layer 104. Meanwhile, the looseness and low stress of the second antireflection film layer 104 can improve the high temperature and high humidity resistance of the optical lens.

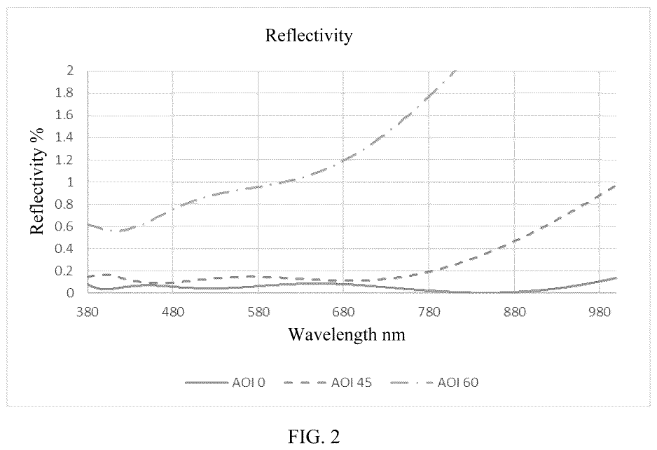

In some embodiments, referring to FIG. 2 and Table 1, FIG. 2 is a curve of reflectivity when light with different incident angles enters the optical lens according to some embodiments of the present disclosure.

TABLE 1

| R %@380-900 nm | AOI 0 | AOI 45 | AOI 60 |
|---|---|---|---|
| Rmax/% | 0.08 | 0.53 | 2.76 |
| Rave/% | 0.05 | 0.18 | 1.29 |

FIG. 2 represents three reflectivity curves with different incident angles. In Table 1, R % @ 380-900 nm represents the wavelength of the incident light, AOI 0 represents the incident angle of 0, AOI 45 represents the incident angle of 45°, AOI 60 represents the incident angle of 60°, Rmax/% represents the maximum overall reflectivity of the first antireflection film layer 103 and the second antireflection film layer 104 at the incident light wavelength of 380 nm-900 nm, and Rave/% represents the average overall reflectivity of the first antireflection film layer 103 and the second antireflection film layer 104 at the incident light wavelength of 380 nm-900 nm.

It can be seen that when the incident angle of the light is 0°, the average reflectivity of the first antireflection film layer 103 and the second antireflection film layer 104 in the 380 nm-900 nm wavelength range is 0.05%, and the maximum reflectivity is only 0.08%, which is lower than 0.1%, significantly reducing the reflectivity of the optical lens. When the incident angle of light is 45°, the average reflectivity of the first antireflection film layer 103 and the second antireflection film layer 104 in the 380 nm-900 nm wavelength range is 0.18%, and the maximum reflectivity is only 0.53%. When the incident angle of light is 60°, the average reflectivity of the first antireflection film layer 103 and the second antireflection film layer 104 in the 380 nm-900 nm wavelength range is only 1.29%, and the maximum reflectivity is only 2.76%, thereby significantly improving the overall optical characteristics.

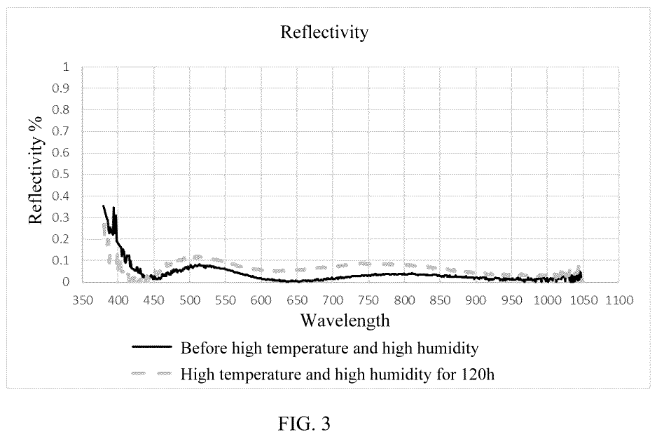

Referring to Table 2, Table 3 and FIG. 3, Table 2 represents the change values of height difference between the highest point and the lowest point on the surface of the lens body 100 before and after testing, Table 3 represents the appearance changes of the optical lens under different testing conditions, and FIG. 3 represents the change curve of the reflectivity of the optical lens before and after testing.

TABLE 2

| Surface of the | Before high temperature | High temperature and high |
|---|---|---|
| lens body | and high humidity | humidity for 120 h |
| Front | 0.3966 μm | 0.2497 μm |
| Back | 0.4234 μm | 0.2743 μm |

TABLE 3

| | | | | |
|---|---|---|---|---|
| Reliability | High temperature | Low temperature | Double-85 high- | Alternating |
| | for 480 h | for 480 h | temperature high- | humidity and |
| | | | humidity for 480 h | heat for 480 h |
| Appearance | No film cracking, | No film cracking, | No film cracking, | No film cracking, |
| | peeling, wrinkling, | peeling, wrinkling, | peeling, wrinkling, | peeling, |
| | etc. | etc. | etc. | wrinkling, etc. |

The data in Table 2 shows the change in height difference between the highest and lowest points on the surface of the lens body 100 before and after testing. It can be seen that the surface change of the film layer before and after testing is relatively small, with a degree of change of smaller than 0.2 μm.

The high temperature in Table 3 refers to the condition of 85° C.±2° C., the low temperature refers to the condition of −40° C.±2° C., and the double 85 high temperature and high humidity refers to conditions at 85° C.±2° C. and 85%+5% RH humidity. Alternating humidity and heat refers to a cyclical test where the initial temperature rises to 85° C.±2° C. and the initial humidity rises to 85° C.±5% RH, and then the temperature drops back to the initial temperature.

It can be seen from Table 3 that, in the optical lens provided by embodiments of the present disclosure has no film cracking, peeling, or wrinkling in the high-temperature environment, the low-temperature environment, the high-temperature high-humidity environment, and the alternating humidity and heat environment, which has good reliability and improves the quality of the captured images.

It can be seen from FIG. 3 that optical lens provided by embodiments of the present disclosure has substantially no change in reflectivity before and after continuous high temperature and high humidity for 120 hours, and has good reliability, thereby ensuring the quality of captured images.

Those skilled in the art can understand that the above embodiments are specific embodiments for implementing the present disclosure, and in practical applications, various changes may be made in form and detail without departing from the spirit and scope of embodiments of the present disclosure. Any one of those skilled in the art can make respective changes and modifications without departing from the spirit and scope of embodiments of the present disclosure, and therefore the protection scope of embodiments of the present disclosure shall be defined by the claims.

What is claimed is:

1. An optical lens, comprising:
a lens body; and
a composite film layer covering on the lens body;
wherein the composite film layer comprises a first intermediate layer, a second intermediate layer, a first antireflection film layer and a second antireflection film layer;
wherein the first intermediate layer covers on a surface of the lens body, the second intermediate layer covers on a surface of the first intermediate layer facing away from the lens body, the first antireflection film layer covers on a surface of the second intermediate layer facing away from the first intermediate layer, and the second antireflection film layer covers on a surface of the first antireflection film layer facing away from the second intermediate layer; and
wherein the second intermediate layer has a smaller refractive index than the first intermediate layer, and the second antireflection film layer has a smaller equivalent refractive index than the first antireflection film layer; a material of the first intermediate layer comprises aluminum oxide, and/or a material of the second intermediate layer comprises silicon-aluminum mixture or silicon dioxide; the first antireflection film layer and the second antireflection film layer comprise silica spherical particles, and a diameter of silica spherical particles in the first antireflection film layer is greater than a diameter of silica spherical particles in the second antireflection film layer.

2. The optical lens as described in claim 1, wherein an equivalent refractive index of the first antireflection film layer is smaller than a refractive index of the second intermediate layer.

3. The optical lens as described in claim 1, wherein an equivalent refractive index of the first antireflection film layer ranges from 1.2 to 1.35, and/or a refractive index of the second intermediate layer ranges from 1.38 to 1.55.

4. The optical lens as described in claim 1, wherein a refractive index of the first intermediate layer ranges from 1.55 to 1.73, and/or an equivalent refractive index of the second antireflection film layer ranges from 1.06 to 1.16.

5. The optical lens as described in claim 1, wherein a thickness of the first intermediate layer is smaller than a thickness of the second intermediate layer, and/or an equivalent thickness of the first antireflection film layer is smaller than an equivalent thickness of the second antireflection film layer.

6. The optical lens as described in claim 1, wherein a thickness of the second intermediate layer is smaller than an equivalent thickness of the first antireflection film layer.

7. The optical lens as described in claim 1, wherein a thickness of the first intermediate layer ranges from 70 nm to 76 nm, and/or a thickness of the second intermediate layer ranges from 75 nm to 80 nm, and/or an equivalent thickness of the first antireflection film layer ranges from 83 nm to 95 nm, and/or an equivalent thickness of the second antireflection film layer ranges from 100 nm to 115 nm.

8. The optical lens as described in claim 1, wherein a material of the lens body comprises EP material, OKP material, SP material or PMMA material.
